(19) United States
(12) Patent Application Publication
(10) Pub. No.: US 2026/0285688 A1
(43) Pub. Date: Sep. 24, 2026

(54) METHOD AND SYSTEM FOR PRODUCING ACTIVATED CARBON

(71) Applicant: VALMET AB, Sundsvall (SE)

(72) Inventors: Andreas AVERHEIM, Sundsvall (SE); Mikael THYREL, Umeå (SE)

(73) Assignee: VALMET AB, Sundsvall (SE)

(21) Appl. No.: 19/473,527

(22) PCT Filed: Mar. 26, 2024
(86) PCT No.: PCT/SE2024/050276

§ 371 Date: Oct. 8, 2025

(30) Foreign Application Priority Data
Apr. 12, 2023 (SE) 2330157-5

(51) Int. Cl. C01B 32/348; C01B 32/324; C01B 32/39

(52) U.S. Cl. CPC C01B 32/348; C01B 32/324; C01B 32/39

(57) ABSTRACT

Disclosed are a method and system for producing activated carbon The method comprises subjecting a carbon containing material to a steam explosion process in order to form a steam exploded carbon containing material, and pyrolyzing the steam exploded carbon containing material such that the activated carbon is formed. The system for producing activated carbon, the system comprises a steam explosion reactor assembly configured to subject a carbon containing material to a steam explosion process in order to form a steam exploded carbon containing material, and a pyrolyzer configured to pyrolyze the steam exploded carbon containing material such that the activated carbon is formed.

The present patent disclosure concerns a method and system for producing activated carbon.

Activated carbon is a form of carbon commonly used to filter contaminants from water and air, among many other uses, for example, as a catalyst for chemical reactions. Another application for activated carbon is the use in energy storage products, such as in battery anodes or supercapacitors. The carbon containing source material may be lignocellulosic biomass, such as by- or waste products of agriculture and forestry. One of the preferred source materials for producing activated carbon for oral use is coconut shells. The source material is processed and activated to produce activated carbon which has small, low-volume pores that increase the surface area for adsorption or chemical reactions.

Activated carbon is usually derived from the lignocellulosic by- or waste products through a physical or chemical activation process. Chemical activation differs from physical activation in that lower temperatures are applied, and a shorter time is needed for activating the material. Generally, chemical activation is considered to result in better quality consistency of the final product. When chemical activation is used, the carbon material is impregnated with certain chemicals, such as an acid, a (strong) base, or a salt. Different chemicals provide different characteristics of the produced activated carbon, such as differences in surface area and pore size distribution. The carbon is then subjected to a pyrolysis process at elevated temperatures, for instance in a range of 250 to 600° C.

A process for producing activated carbon that uses chemical activation from lignocellulosic biomass typically comprises drying of the lignocellulosic biomass, extensive grinding of the dried biomass, chemical activation of the grinded dried biomass and pyrolyzing the grinded dried biomass.

It is an object, among objects, to provide an improved method and system for producing activated carbon.

To this end, a method for producing activated carbon is provided, the method comprising subjecting a carbon containing material to a steam explosion process such that a steam exploded carbon containing material is formed; and pyrolyzing the steam exploded carbon containing material such that the activated carbon is formed.

Beneficially, the method, including the steam explosion process, results in activated carbon having up to a 20% increase in BET surface area—of which a 29% increase in micropore area, and a 9.2% increase in mesopore area—compared to activated carbon produced in the same manner but without the steam explosion step. In addition, the pore volume of the activated carbon produced by the above method increases up to 21% compared to activated carbon produced without the steam explosion process.

With this improved activated carbon, less activated carbon is required to achieve the same effect, such as in adsorption processes.

A further advantage is that the process may no longer require the drying and grinding steps of when treating the carbon containing material such as lignocellulosic biomass. In case the grinding step is still desired, depending on the carbon containing material used, the grinding can be more moderate compared to grinding in previous methods for producing activated carbon.

In an embodiment, the method comprises physical and/or chemical activation of at least one of the carbon containing material and the steam exploded carbon containing material.

In an embodiment, the method comprises chemically treating at least one of the carbon containing material and the steam exploded carbon containing material.

Advantageously, the present method requires less activation chemicals are required to produce activated carbon with the same properties, or even better properties, than activated carbon produced without the steam explosion process.

In an embodiment, the chemically treating is chemically activating.

In an embodiment, the chemically activating comprises exposing at least one of the carbon containing material or the steam exploded carbon containing material to an activation compound.

In an embodiment, the activation compound comprises at least one of sodium hydroxide, potassium hydroxide, potassium carbonate, calcium chloride, copper chloride, nickel chloride, manganese chloride, magnesium chloride, zinc chloride, and phosphoric acid.

In an embodiment, the activation compound is potassium hydroxide or zinc chloride.

In an embodiment, the method comprises drying the steam exploded carbon containing material and thereafter pyrolyzing the dried steam exploded carbon containing material.

In an embodiment, the method comprises grinding the steam exploded carbon containing material.

In an embodiment, the steam explosion process comprises using a catalyst.

In an embodiment, the catalyst comprises at least one of sulfuric acid or sulphur dioxide.

In an embodiment, the amount of sulphuric acid lies in the range of 0 to 5 wt %, preferably 0.1 to 4 wt %, more preferably 1 to 3 wt % by weight of the carbon containing material.

In an embodiment, the steam explosion process comprises supplying the carbon containing material to a reactor; treating the carbon containing material in the reactor at a first pressure; and discharging the carbon containing material from the reactor to a vessel, wherein the vessel is at a second pressure that is lower than the first pressure so that the carbon containing material is treated by steam explosion as it passes from the reactor.

In an embodiment, the carbon containing material is continuously supplied to and discharged from the reactor in such a way that the first pressure is constant.

In an embodiment, the carbon containing material is supplied to the reactor using a plug screw.

In an embodiment, the vessel is connected to the reactor via a blowline.

In an embodiment, the first pressure lies in a range of 6 to 34 bar, preferably 10 to 23 bar, more preferably 11 to 19 bar.

In an embodiment, the carbon containing material is treated in the reactor at a temperature of 160° C. to 240° C., preferably 180° C. to 220° C., more preferably 190° C. to 210° C.

In an embodiment, the residence time of the carbon containing material in the reactor lies in the range of 1 to 60 minutes, preferably 3 to 20 minutes, most preferably within 5 to 15 minutes.

In an embodiment, the liquids-to-solids ratio in the reactor is in the range of 0.1:1-10:1, preferably 0.5:1-2:1. In the present field, liquids-to-solids ratios are generally expressed in weight:weight. It will thus be understood by a skilled person that the liquids-to-solids ratios mentioned in the present disclosure are liquids-to-solids weight ratios. The liquids comprise mainly water and degradation products of the carbon containing material. The degradation products may comprise any one or more of acetic acid, furfural, formic acid, 5-hydroxymethylfurfural, and levulinic acid. Typically, the water phase comprises acetic acid at a maximum of 0.5 to 6 wt %.

In an embodiment, at least a part of heat of steam produced during the pyrolyzing is used for the steam explosion process.

In an embodiment, the provided carbon containing material comprises or is lignocellulosic biomass. The lignocellulosic biomass may comprise or be wood bark.

In accordance with a second aspect, there is provided a system for producing activated carbon, the system comprising a steam explosion reactor assembly configured to subject a carbon containing material to a steam explosion process to form a steam exploded carbon containing material; and a pyrolyzer configured to pyrolyze the steam exploded carbon containing material such that the activated carbon is formed.

Beneficially, the system, including the steam explosion reactor assembly, in use produces activated carbon having up to a 20% increase in BET surface area—of which a 29% increase in micropore area, and a 9.2% increase in mesopore area-compared to activated carbon produced in the same manner but without the steam explosion step. In addition, the pore volume of the activated carbon produced by the above system increases up to 21% compared to activated carbon produced without the steam explosion process.

It will be apparent that the advantages given for the method according to the first aspect apply to the system according to the second aspect, and these advantages are not repeated here for sake of efficiency.

In an embodiment, the system is configured to mix the carbon containing material or the steam exploded carbon containing material with an activation compound or chemical. The activation compound may comprise at least one of sodium hydroxide, potassium hydroxide, potassium carbonate, calcium chloride, copper chloride, nickel chloride, manganese chloride, magnesium chloride, zinc chloride, and phosphoric acid.

In an embodiment, the steam explosion reactor assembly comprises: a reactor configured to treat the carbon containing material at a first pressure; and a vessel configured to receive the treated carbon containing material from the reactor, wherein the steam explosion reactor assembly is configured to treat the carbon containing material in the reactor at a first pressure, and discharge the carbon containing material from the reactor to the vessel, wherein the vessel is at a second pressure that is lower than the first pressure so that the carbon containing material is treated by steam explosion as it passes from the reactor.

In an embodiment, the steam explosion reactor assembly comprises a plug screw configured to supply the carbon containing material to the reactor such that the first pressure remains constant. Constant may indicate that the pressure remains within 90% to 110% of the set pressure, preferably within 95% and 105% of the set pressure.

The reactor may be connected to the vessel via a blowline. The blowline may comprise a blow nozzle.

The carbon containing material may be of lignocellulosic origin.

In the present application, a steam explosion discharge may be performed by passing the material from the reactor through a pressure-reducing restriction. The pressure-reducing restriction may be a valve or a fixed restriction, such as an orifice plate. The carbon containing material and steam are then rapidly accelerated due to pressure reduction and volume expansion of the steam in a matter of a few milliseconds (ms). The steam explosion, which comprises the pressure reduction and volume expansion, may occur in less than 50 ms, less than 30 ms, less than 20 ms, or less than 10 ms. This velocity facilitates the transportation of the material to the vessel, for instance via the blowline, at a lower pressure. Flashing may also occur when the pressure is lowered. The speed of the pressure reduction and volume expansion has an effect on the pore volume of the produced activated carbon and on the relative proportion of the pore types (e.g. mesopores or micropores).

The reactor may be positioned either in a vertical or horizontal orientation. A horizontally oriented reactor is preferably equipped with an auger conveyor for transporting the material forward. A vertically oriented reactor uses gravity for transporting the material towards the output. In an embodiment, the reactor comprises a discharge device or discharger arranged at an outlet end thereof. The discharge device may comprise one or more screw conveyors. The discharge device additionally or alternatively may comprise one or several discharge screws. When oriented vertically, the reactor preferably comprises a bottom scraper. The bottom scraper may comprise a rotatable arm arranged in the lower part of the reactor and configured to scrape the walls such that the material is discharged towards in the direction of the center of the reactor.

The vessel may be embodied as a steam separating device. The steam separating device may be implemented as a cyclone, a tank or a mechanical steam separator.

The vessel may be configured to operate at a pressure in the range of 0.5 bar to 10 bar, preferably 1 bar to 4 bar.

It will be understood that technical advantages and effects associated with features and/or embodiments of one aspect, apply to the corresponding, similar or equivalent features and/or embodiments the other aspects. It will also be apparent that the features of the various aspects and/or embodiments thereof may be applied to the other aspects and/or embodiments thereof.

### BRIEF DESCRIPTION OF THE DRAWINGS

The accompanying drawings are used to illustrate presently preferred non-limiting exemplary embodiments of devices of the present disclosure. The above and other advantages of the features and objects of the disclosure will become more apparent, and the aspects and embodiments will be better understood from the following detailed description when read in conjunction with the accompanying drawings, in which:

FIG. 1 illustrates a method according to an embodiment of the present patent disclosure;

FIG. 2 illustrates a method according to an embodiment of the present patent disclosure;

FIG. 3 illustrates a method according to an embodiment of the present patent disclosure;

FIG. 4 illustrates a method according to an embodiment of the present patent disclosure;

FIG. 5 illustrates a method according to an embodiment of the present patent disclosure;

FIG. 6 illustrates a system according to an embodiment of the present patent disclosure;

FIG. 7 illustrates a system according to an embodiment of the present patent disclosure; and

FIG. 8 illustrates a plot of impurity uptake for activated carbon samples according to the invention and references carbon samples.

### DETAILED DESCRIPTION OF PREFERRED EMBODIMENTS

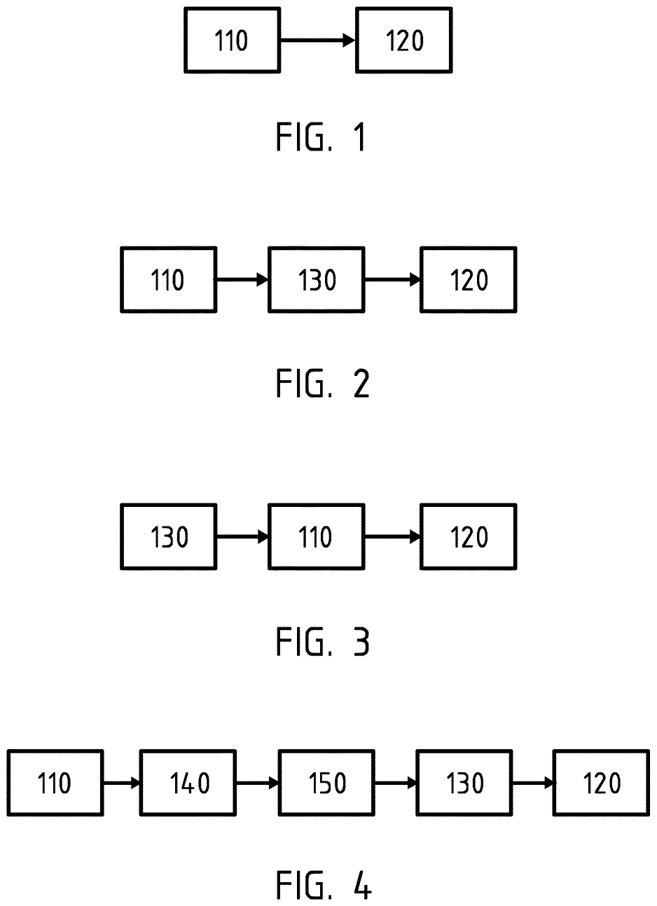

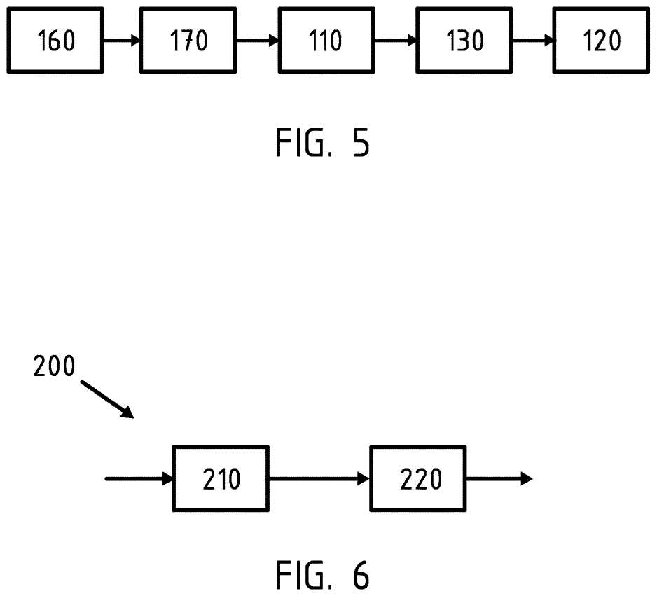

As shown in FIG. 1, there is provided a method for producing activated carbon comprises a step of subjecting 110 a carbon containing material to a steam explosion process such that a steam exploded carbon containing material is formed; and a step of pyrolyzing 120 the steam exploded carbon containing material such that the activated carbon is formed.

In FIG. 2, the method comprises a step of chemically treating, or chemical activation, 130 of the steam exploded carbon containing material. The chemically activated carbon containing material is then pyrolyzed. The chemical activation may be performed by chemically treating the steam exploded carbon containing material.

Alternatively, as shown in FIG. 3, the chemical activation step 130 may be performed on the carbon containing material before the steam explosion process. A combination of these two options is also possible, that is, that both the carbon containing material is chemically treated or impregnated while also the steam exploded carbon containing material is chemically treated or impregnated.

The chemically activating may comprise exposing at least one of the carbon containing material or the steam exploded carbon containing material to an activation compound. The activation compound may comprise at least one of sodium hydroxide, potassium hydroxide, potassium carbonate, calcium chloride, copper chloride, nickel chloride, manganese chloride, magnesium chloride, zinc chloride, and phosphoric acid. The exposing may include mixing the activation compound with the carbon containing material and/or allowing the carbon containing material to be impregnated with the activation compound.

As shown in FIG. 4, the method may comprise drying 140 the steam exploded carbon containing material. Thereafter the dried steam exploded carbon containing material is chemically treated under step 130 and then pyrolyzed in step 120. The chemically treating or activating step 130 may be performed before the steam explosion step 110, or between the steam explosion 110 and the drying step 150. Optionally, the method includes a step 150 of grinding the dried steam exploded carbon containing material between the drying step 140 and the step 120 of pyrolyzing or the step 130 of chemically activating. The step 130 of chemically activating may alternatively be done before the step 110, between steps 110 and 140, between steps 140 and 150, or during step 150.

The steam explosion process may comprise supplying the carbon containing material to a reactor and treating the carbon containing material in the reactor at a first pressure for an amount of time, which may be 10 minutes, for instance. Thereafter, the treated carbon containing material is discharged to a vessel, which is at a second pressure that is lower than the first pressure so that the carbon containing material is treated by steam explosion as it passes from the reactor. This may be done in batches or in a continuous manner. When done in a continuous manner, the reactor is fed with the carbon containing material such that the first pressure remains constant, i.e. within 10% of the desired pressure. To do so, the carbon containing material may be fed to the reactor using a plug screw.

The vessel may be connected to the reactor via a blowline. The first pressure typically lies in a range of 6 to 34 bar, preferably 10 to 23 bar, more preferably 11 to 19 bar. The temperature in the reactor is typically in the range of 160° C. to 240° C., preferably 180° C. to 220° C., more preferably 190° C. to 210° C. A blowline may be a pipe configured to direct the steam and carbon containing material to the next process stage, in this case the steam separation.

The residence time of the carbon containing material in the reactor generally lies in the range of 1 to 60 minutes, preferably 3 to 20 minutes, most preferably within 5 to 15 minutes. The liquids-to-solids ratio in the reactor is in the range of 0.1:1-10:1, preferably 0.5:1-2:1.

The steam explosion process may be done using a catalyst, which may be sulfuric acid or sulphur dioxide. When using sulphuric acid, the amount thereof may be in the range of 0 to 5 wt %, preferably 0.1 to 4 wt %, more preferably 1 to 3 wt % by weight of the carbon containing material.

The provided carbon containing material may comprise, or may be, lignocellulosic biomass. The lignocellulosic biomass may comprise, or may be, wood bark.

A system 200 for producing activated carbon is schematically shown in FIG. 6. The system 200 comprises a steam explosion reactor assembly 210 configured to subject a carbon containing material to a steam explosion process to form a steam exploded carbon containing material and a pyrolyzer 220 configured to pyrolyze the steam exploded carbon containing material such that the activated carbon is formed. The system 200 may be configured to perform any of the methods described above.

Referring to FIG. 3, in the system 300 for producing activated carbon, the steam explosion reactor assembly 210 comprises a reactor 310 configured to treat the carbon containing material at a first pressure and a vessel 380 configured to receive the treated carbon containing material from the reactor 310. The steam explosion reactor assembly 310 is configured to treat the carbon containing material in the reactor at a first pressure and to discharge the carbon containing material from the reactor to the vessel 380, wherein the vessel 380 is at a second pressure that is lower than the first pressure so that the carbon containing material is treated by steam explosion as it passes from the reactor 310. The vessel 380 is here embodied as a blow cyclone. The vessel 380 comprises a first vessel output 384 that outputs steam and a second vessel output 386 that outputs the steam exploded carbon containing material.

The reactor assembly 210 comprises a discharger 370, which is connected to the reactor 310 at the outlet end 318 thereof. The discharger 370 may comprise one or several discharge conveyors, such as discharge screws, configured such that the pressure within the reactor 310 remains constant.

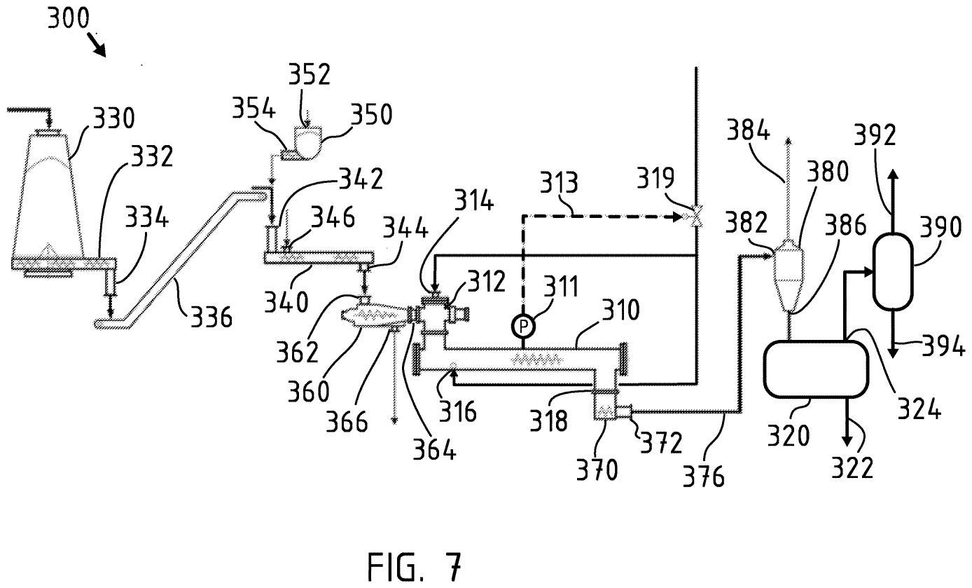

The system 300 may comprise a pressure controller 311 which is connected to the reactor 310. The pressure controller 311 is configured to control the valve 319 arranged to control the supply of steam towards the reactor 310. The steam may be provided in one or more locations in the reactor 310. In FIG. 7, the steam is provided into first steam inlet 314, positioned at or near the reactor inlet end 312 and second steam inlet 316 positioned at an intermediate position along the reactor 310. The reactor 310 is in this configuration positioned horizontally, as described above, and comprises one or more conveyors, such as screw conveyors, in order to move the carbon containing material towards the outlet 318.

The system 300 comprises a plug screw 360 arranged to feed the reactor 310 with carbon containing material form a first output 364 thereof. The plug screw 360 is configured to supply the carbon containing material to the reactor such that the pressure in the reactor 310 remains constant. Constant may indicate that the pressure remains within 90% to 110% of the set pressure, preferably within 95% and 105% of the set pressure. The plug screw 360 may comprise a second output 366 for outputting pressate fluids. The pressate fluids comprise water, extractives, inorganics originating from the biomass, and/or traces of solid biomass. The water may be the excess water present in the biomass. Typically, a plug screw compresses to 50-60% dry matter. The original biomass can contain more water that is being pressed out in this position.

The system 300 further comprises pyrolyzer 320 which receives the steam exploded carbon containing material from the vessel 380. The pyrolyzer is configured to operate at temperatures of at least 250° C., preferably at least 400° C., more preferably at least 600° C., such as 700° C. or 800° C., in an environment having a low partial pressure of oxygen. The average retention time within the pyrolyzer is in the range of 30 minutes to 180 minutes. The pyrolyzer 320 comprises a first pyrolyzer output 322 for outputting solids including the produced activated carbon. The pyrolyzer further comprises a second pyrolyzer output 324 for outputting gases resulting from the pyrolysis of the carbon containing material, which are then fed to an optional separator or condenser 390 which may condense substances like (bio-)oils via a bottom output 394. Remaining gases are then output via the upper output 392 of the separator 390. Alternatively, a combustion chamber may be provided which may burn the gases coming out from pyrolyzer 320 and the combustion heat may be used to heat the pyrolyzer 320, for instance.

The system 300 may further comprise a raw material container 330 including an inlet 331, an outlet 334 and a discharge screw 332 for moving raw material towards the outlet 334. The raw material is a carbon containing material, for instance lignocellulosic biomass, such as wood bark. The carbon containing material is in granular form. When wood bark is used, the wood bark may be shredded or chipped. The system 300 further comprises a belt conveyor 336 and a screw conveyor 340. The belt conveyor 336 is arranged to receive the carbon containing material from the outlet 334 and to transport the material to the screw conveyor 340. In the screw conveyor 340, the carbon containing material may be mixed with an activation compound, which may be provided to the screw conveyor 340 by the outlet 354 of the activation compound container 352, which further comprises an inlet 352 for receiving the activation compound. The screw conveyor 340 comprises an outlet 344 which is arranged in communication with the input 362 of the plug screw 360. The screw conveyor 340 is arranged in this configuration to mix the carbon containing material with the activation compound. The screw conveyor 340 may comprise a further inlet 346 for receiving a further activation compound. It is noted that, depending on the raw material used, the components taking the raw material from container 330 to screw conveyor 340 can be exchanged with suitable other components. In this case, as an example, suitable components for wood chips are shown. Even for wood chips these components may be varied.

The activation compound may alternatively be mixed with the steam exploded carbon containing material, between the outlet 386 of the vessel 380 and the pyrolyzer 320. In that case, there may be a mixer, which may be embodied as a screw conveyor, provided between the vessel 380 and the pyrolyzer 320.

### Example 1

Chipped wood bark was provided as the carbon containing material. Four activated carbon samples were produced. For all samples, the applied method comprises chemical activation and pyrolysis. Reference samples produced without steam explosion were pyrolyzed at 600° C. (“RS600”) and 800° C. (“RS800”) respectively. Further samples (“SE600” and “SE800”) were subjected to the steam explosion process, followed by chemical activation and pyrolysis in the same manner as the reference samples. The steam explosion process was done at a temperature of 200° C., a residence time of 10 min, a liquids-to-solids ratio of 1.5:1 in the reactor, a pressure of 15.55 bar and with 2% sulfuric acid per weight of the carbon containing material. ZnCl₂ was used as the activation chemical in a ratio of 1:1 to 2:1 ZnCl₂:carbon containing material. Then water was added under continuous kneading. Water was added until a homogeneous paste was formed.

TABLE 1
Results for activated carbon samples produced with and without
the steam explosion process. “RS” denotes reference samples
without steam explosion, “SE” denotes samples with steam
explosion. The “600” and “800” denote the pyrolysis temperature in ° C.

| | | | | S_{MESO}/ | S_{MICRO}/ | Pore |
|---|---|---|---|---|---|---|
| | S_{BET} | S_{MESO} | S_{MICRO} | S_{BET} | S_{BET} | volume |
| Sample | (m² g⁻¹) | (m² g⁻¹) | (m² g⁻¹) | (%) | (%) | (cm³ g⁻¹) |
| RS600 | 1217 | 615 | 602 | 50.5 | 49.5 | 0.27 |
| SE600 | 1308 | 645 | 662 | 49.3 | 50.7 | 0.30 |
| RS800 | 1018 | 490 | 528 | 48.2 | 51.8 | 0.24 |
| SE800 | 1217 | 535 | 682 | 44 | 56 | 0.29 |

TABLE 2
Increase in percent in the surface areas and pore volume of Table
1 for samples with steam explosion versus without steam explosion.

| | SE600 | SE800 |
|---|---|---|
| | (%) | (%) |
| S_{BET} | 7.5 | 19.5 |
| S_{MESO} | 4.9 | 9.2 |
| S_{MICRO} | 10.0 | 29.2 |
| Pore volume | 11.1 | 20.8 |

Referring to the above tables 1 and 2, the steam exploded samples show up to a 20% BET surface area and micropore area compared to the reference samples. The micropore surface area increase contributes the most to the BET surface area, which is the most wanted surface area in activated carbon. Also, the mesopore area increased compared to the reference samples.

### Example 2

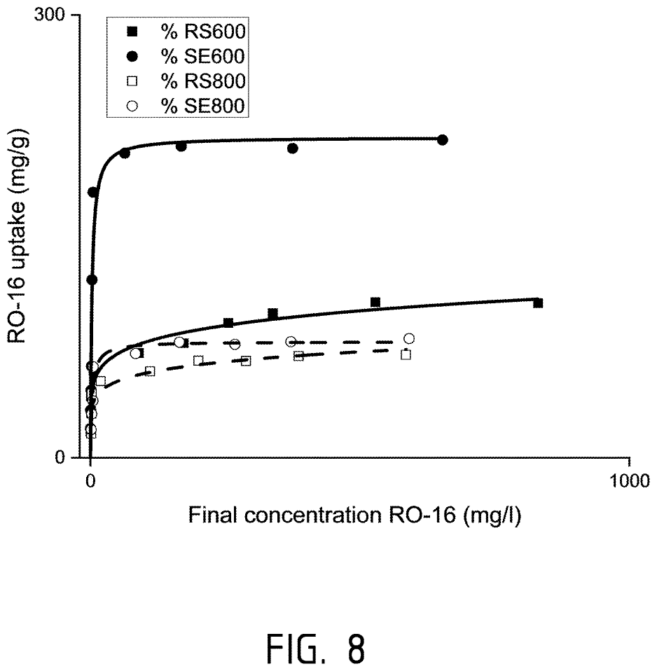

Adsorption tests to study impurity uptake by the various samples was done with reactive orange 16 (RO-16, 2-naphthalenesulfonic acid) as an impurity. Solutions of RO-16 at different concentrations were subjected to a controlled amount of produced activated carbon from the samples RS600, SE600, RS800 and SE800 for approximately 20 hours. The activated carbon was then removed from the solution, and the final RO-16 concentration was measured. The impurity uptake by the carbons was then calculated based on the difference between the final and starting concentration of the RO-16. The results are shown in FIG. 8. The x-axis shows the final concentration of RO-16 in mg/l, the y-axis shows the RO-16 uptake in mg/g of carbon. The plateaus at higher final concentrations of RO-16 indicate the saturation RO-16 uptake of the carbon.

The results show that the steam-exploded carbon (SE600 and SE800 samples) had a higher uptake compared to the ones without steam explosion (RS600 and RS800). At 600 degrees pyrolysis temperature the improvement was more than two-fold.

Although the present invention has been described with reference to specific embodiments, also shown in the appended drawings, it will be apparent to those skilled in the art that many variations and modifications can be done within the scope of the invention as described in the specification and defined with reference to the claims below.

1. A method for producing activated carbon, the method comprising:
subjecting a carbon containing material to a steam explosion process in order to form a steam exploded carbon containing material; and
pyrolyzing the steam exploded carbon containing material such that the activated carbon is formed.

2. The method according to claim 1, further comprising chemically treating at least one of the carbon containing material and the steam exploded carbon containing material.

3. The method according to claim 2, wherein the chemically treating is chemically activating.

4. The method according to claim 3, wherein the chemically activating comprises exposing at least one of the carbon containing material or the steam exploded carbon containing material to an activation compound, wherein the activation compound comprises at least one of sodium hydroxide, potassium hydroxide, potassium carbonate, calcium chloride, copper chloride, nickel chloride, manganese chloride, magnesium chloride, zinc chloride, and phosphoric acid.

5. The method according to claim 4, wherein the activation compound is potassium hydroxide or zinc chloride.

6. The method according to claim 1, wherein the steam explosion process is performed by passing the carbon containing material through a pressure-reducing restriction, such as a fixed restriction, a valve or an orifice plate.

7. The method according to claim 1, wherein a liquids-to-solids weight ratio in the steam explosion process is in the range of 0.1:1-10:1.

8. The method according to claim 1, further comprising drying the steam exploded carbon containing material and thereafter pyrolyzing the dried steam exploded carbon containing material.

9. The method according to claim 1, further comprising grinding the steam exploded carbon containing material.

10. The method according to claim 1, wherein the steam explosion process comprises using a catalyst.

11. The method according to claim 10, wherein the catalyst comprises at least one of sulfuric acid or sulfur dioxide.

12. The method according to claim 1, wherein the steam explosion process comprises:
supplying the carbon containing material to a reactor;
treating the carbon containing material in the reactor at a first pressure; and
discharging the carbon containing material from the reactor to a vessel, wherein the vessel is at a second pressure that is lower than the first pressure so that the carbon containing material is treated by steam explosion as it passes from the reactor.

13. The method according to claim 12, wherein the carbon containing material is continuously supplied to and discharged from the reactor in such a way that the first pressure is constant.

14. The method according to claim 13, wherein the carbon containing material is supplied to the reactor using a plug screw.

15. The method according to claim 12, wherein the vessel is connected to the reactor via a blowline.

16. The method according to claim 12, wherein the first pressure lies in a range of 6 to 34 bar.

17. The method according to claim 12, wherein the carbon containing material is treated in the reactor at a temperature of 160° C. to 240° C.

18. The method according to claim 1, wherein at least a part of heat of steam produced during the pyrolyzing is used for the steam explosion process.

19. The method according to claim 1, wherein the provided carbon containing material comprises or is lignocellulosic biomass.

20. A system for producing activated carbon, the system comprising:
a steam explosion reactor assembly configured to subject a carbon containing material to a steam explosion process in order to form a steam exploded carbon containing material; and
a pyrolyzer configured to pyrolyze the steam exploded carbon containing material such that the activated carbon is formed.

21. The system according to claim 20, wherein the steam explosion reactor assembly comprises: a reactor configured to treat the carbon containing material at a first pressure; and
a vessel configured to receive the treated carbon containing material from the reactor,
wherein the steam explosion reactor assembly is configured to
treat the carbon containing material in the reactor at a first pressure, and
discharge the carbon containing material from the reactor to the vessel, wherein the vessel is at a second pressure that is lower than the first pressure so that the carbon containing material is treated by steam explosion as it passes from the reactor.

22. The system according to claim 21, wherein the steam explosion reactor assembly comprises a plug screw configured to supply the carbon containing material to the reactor such that the first pressure remains constant.

23. The system according to claim 21, wherein the steam explosion reactor assembly comprises a pressure-reducing restriction between the reactor the vessel.

24. The system according to claim 20, wherein the steam explosion reactor assembly is configured to subject the carbon containing material to a steam explosion process with a liquids-to-solids weight ratio in the range of 0.1:1-10:1.
